(19) United States
(12) Patent Application Publication
(10) Pub. No.: US 2014/0008097 A1
(43) Pub. Date: Jan. 9, 2014

(54) ELECTRIC WIRE

(71) Applicants: Kinya SUGIE, Osaka-shi (JP); Hiroshi HIRAIKE, Sakai-shi (JP)

(72) Inventors: Kinya SUGIE, Osaka-shi (JP); Hiroshi HIRAIKE, Sakai-shi (JP)

(73) Assignee: KYOWA ELECTRIC WIRE CO., LTD., Osaka (JP)

(21) Appl. No.: 13/544,015

(22) Filed: Jul. 9, 2012

(51) Int. Cl. H01B 7/20; H01B 13/06

(52) U.S. Cl. 174/102 R; 156/51

(57) ABSTRACT

An electric wire of the present invention includes: (a) a conductive wire divided into a plurality of regions by a first insulating film extending in a longitudinal direction; (b) a second insulating film that coats a longitudinal periphery of the conductive wire; and (c) a conductive pipe that surrounds, without any space, the conductive wire in the longitudinal direction while sandwiching the second insulating film. Each of the divided regions of the conductive wire has a minor axis less than twice as large as a skin thickness at a working frequency. A wall thickness of the conductive pipe is smaller than the skin thickness at the working frequency.

### BACKGROUND OF THE INVENTION

1. Field of the Invention

The present invention relates to an electric wire suitable for a motor (electric motor), a generator coil or a transmission wire.

2. Description of Related Art

A stator of a motor is obtained by winding a coil wire around a stator core. A current with a predetermined frequency is allowed to flow through this coil wire, to drive the motor. When a high-frequency current flows through the coil wire, a current density becomes high on the surface of the coil wire and becomes low inside the coil wire. This is called a skin effect. The higher the frequency becomes, the more the current concentrates on the surface, resulting in an increased current resistance value of the electric wire.

FIG. 6 is a sectional view of a general motor 100 (JP-A-2010-28958). The motor 100 is provided with a stator 101 and a rotor 102. A stator coil 104 is wound around a stator core 103. The rotor 102 rotates around a rotating shaft 105.

A lower left part of FIG. 6 is an enlarged sectional view of the stator coil 104. The stator coil 104 is obtained by multiply-winding a coil wire 106 having a circular cross section. Even when the coil wire 106 is wound in a geometrically perfect hexagonal close-packed array, an about 10%-space is generated as a cross-sectional area between the coil wires 106. The coil wires 106 in effect cannot be wound in a geometrically perfect hexagonal close-packed array, thus leading to generation of a larger space. In an experiment performed by the applicant, even when the coil wire 106 was carefully wound, an about 30%-space was generated as a cross-sectional area. For this reason, in the case of winding the coil wire 106 having a circular cross section, it is difficult to have a high current density of the stator coil 104.

FIG. 7 is a sectional view of a stator coil 110 of another conventional motor (JP-A-2009-225507). The stator coil 110 is wound around a stator core 111. With a coil wire 112 having a rectangular cross section, the stator coil 110 can be wound around the stator core 111 with almost no space generated. For this reason, it is possible to make a current density of the stator coil 110 higher than the current density of the coil wire 106 (FIG. 6) having a circular cross section.

When a frequency of the current allowed to flow through the motor becomes high, the skin effect occurs in the coil wire. FIG. 8 is a graph showing that the current density decreases due to the skin effect. A horizontal axis, a left vertical axis and a right vertical axis of FIG. 8 respectively represent a current frequency, a skin depth and a relative current density. The relative current density of the right vertical axis of FIG. 8 is displayed taking the case of a direct current as 100%. FIG. 8 is a calculated value obtained using as a model a copper-made coil wire having a rectangular cross section of 3.2 mm×1.7 mm.

As shown in FIG. 8, in the case of the copper-made coil wire having a rectangular cross section of 3.2 mm×1.7 mm, when the current frequency exceeds about 4 kHz, the relative current density begins to decrease. The relative current density decreases to 50% at the current frequency of about 30 kHz, and the relative current density decreases to 20% at the current frequency of about 200 kHz. For this reason, when the motor is driven by a high-frequency current, a decrease in current density due to the skin effect of the coil wire becomes a problem.

Increasing a surface area of the coil wire (that is, thinning the coil wire to increase the number thereof) can alleviate the influence of the skin effect of the coil wire. For winding the coil wire without any space, the coil wire preferably has a rectangular cross section. However, it is difficult in terms of production techniques to wind a thin coil wire having a rectangular cross section without any space. The coil wire having a circular cross section can be tightly wound with ease even when the wire is thin. However, since a space is inevitable between the coil wires, it is difficult to make the current density high.

### SUMMARY OF THE INVENTION

The coil wire having a circular cross section can be wound tightly even when the wire is thin. However, since a space is inevitable between the coil wires, it is difficult to make the current density high. When the thin coil wire having a rectangular cross section can be wound without any space, it is possible to make the current density high. However, it is in effect difficult to wind the wire without any space. For this reason, both making the current density high and alleviating the skin effect have not been satisfied in the past.

It is an object of the present invention to realize an electric wire for a coil on which a small influence of the skin effect is exerted, and which can make a current density high and can be wound without any space. The electric wire of the present invention is applicable not only to a coil, but also to a transmission wire and the like.

The summary of the present invention is as below.

In a first preferred aspect of the present invention, an electric wire includes: (a) a conductive wire divided into a plurality of regions by a first insulating film extending in a longitudinal direction; (b) a second insulating film that coats a longitudinal periphery of the conductive wire; and (c) a conductive pipe that surrounds, without any space, the conductive wire in the longitudinal direction while sandwiching the second insulating film.

In a second preferred aspect of the electric wire according to the present invention, each of the plurality of divided regions of the conductive wire has a minor axis less than twice as large as a skin thickness at a working frequency. A wall thickness of the conductive pipe is smaller than the skin thickness at the working frequency.

In a third preferred aspect of the present invention, the electric wire has an insulating film on the outer surface of the conductive pipe.

In a fourth preferred aspect of the electric wire according to the present invention, a cross-sectional outer shape of the conductive pipe is a circle, a rectangle or a hexagon.

In a fifth preferred aspect of the electric wire according to the present invention, each material of the conductive wire and the conductive pipe is any one of copper, a copper alloy, aluminum and an aluminum alloy, or a combination of those.

In a sixth preferred aspect of the present invention, a method for manufacturing an electric wire includes the steps of: (a) preparing a conductor tape; (b) preparing a plurality of thin conductive wires whose surfaces are coated by an insulating film; (c) making directions of the plurality of thin conductive wires uniform and placing the wires on the conductor tape; (d) rolling the conductor tape and bonding a longitudinal end surface of the conductor tape to give a conductive pipe, and accommodating the plurality of thin conductive wires inside the conductive pipe; and (e) integrating the plurality of thin conductive wires and the conductive pipe, forming a conductive wire having a plurality of regions divided by a first insulating film, while simultaneously surrounding the conductive wire in the longitudinal direction without any space by means of the conductive pipe via a second insulating film.

In a seventh preferred aspect of the present invention, the method further includes a step of annealing the integrated conductive pipe and the conductive wire.

In an eighth preferred aspect of the present invention, the method further includes a step of coating the outer surface of the conductive pipe by an insulating film.

### ADVANTAGES OF THE INVENTION

According to the present invention, there was realized an electric wire on which a small influence of the skin effect is exerted even when a high frequency current is allowed to flow, and which can make a current density high and can be easily wound without any space.

For a full understanding of the present invention, reference should now be made to the following detailed description of the preferred embodiments of the invention as illustrated in the accompanying drawings.

### BRIEF DESCRIPTION OF THE DRAWINGS

FIG. 1 (a) is a sectional view of a thin conductive wire used in the present invention,

FIG. 1 (b) is a sectional view of a thin conductive wire bundle used in the present invention,

FIG. 1 (c) is a sectional view of the thin conductive wire bundle and a conductive pipe used in the present invention,

FIG. 1 (d) is a sectional view of the conductive wire and the conductive pipe used in the present invention,

FIG. 1 (e) is a sectional view of a conductive wire and a conductive pipe used in the present invention, and

FIG. 1 (f) is a sectional view of an electric wire of the present invention;

FIG. 2 is a graph (calculated value) showing a skin effect alleviation status of the electric wire of the present invention;

FIG. 3 is a graph (measured value) showing a skin effect alleviation status of the electric wire of the present invention;

FIG. 4 (a) is a sectional view of a thin conductive wire used in the present invention,

FIG. 4 (b) is a sectional view of a thin conductive wire bundle used in the present invention,

FIG. 4 (c) is a sectional view of the thin conductive wire bundle and a conductive pipe used in the present invention,

FIG. 4 (d) is a sectional view of the conductive wire and the conductive pipe used in the present invention,

FIG. 4 (e) is a sectional view of a conductive wire and a conductive pipe used in the present invention, and

FIG. 4 (f) is a sectional view of an electric wire of the present invention;

FIG. 5 is an explanatory view of a manufacturing process of continuously inserting the thin conductive wire bundle into the conductive pipe;

FIG. 6 is a sectional view of a conventional general motor;

FIG. 7 is a sectional view of a stator coil of another conventional motor; and

FIG. 8 is a graph showing that a current density decreases due to a skin effect.

### DESCRIPTION OF THE PREFERRED EMBODIMENTS

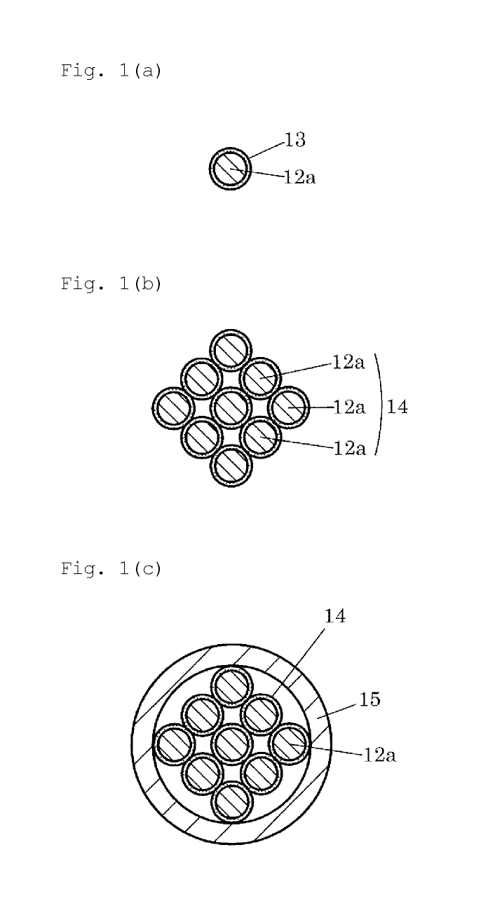

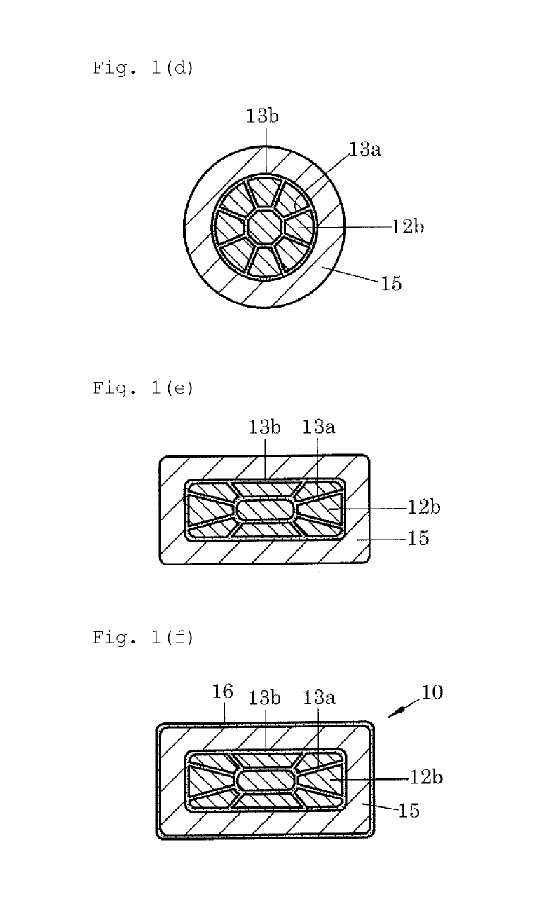

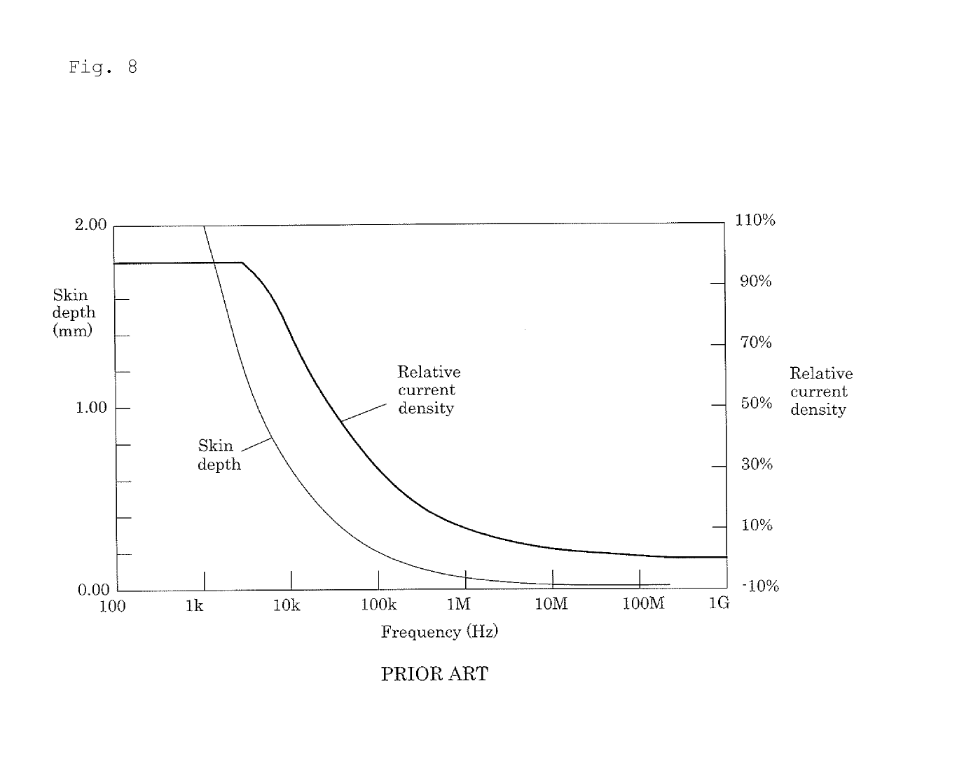

The preferred embodiments of the present invention will now be described with reference to FIGS. 1 to 8 of the drawings. Identical elements in the various figures are designated with the same reference numerals.

An electric wire of the present invention includes: a conductive wire divided into a plurality of regions by a first insulating film extending in a longitudinal direction; a second insulating film that coats a longitudinal periphery of the conductive wire; and a conductive pipe that surrounds, without any space, the conductive wire in the longitudinal direction while sandwiching the second insulating film.

Cross sectional shapes, cross-sectional areas and materials of the plurality of divided regions of the conductive wire may not be identical. A wall thickness of the conductive pipe may vary depending on places. A thickness of the first insulating film and a thickness of the second insulating film may not be fixed so long as insulation is ensured. A material of the first insulating film and a material of a second insulating film may vary depending on places. A material of the conductive wire and a material of the conductive pipe may be different from each other.

When the plurality of divided regions of the conductive wire have polygonal cross sections, the smallest side length is referred to as a minor axis of the region. The minor axis of the region is preferably less than twice as large as a skin depth at a working frequency. In that case, a current flows across the cross section of the conductive wire, thus reducing the occurrence of a decrease in current density due to the skin effect.

The wall thickness of the conductive pipe is preferably smaller than the skin depth at the working frequency. In that case, a current flows across the cross section of the conductive pipe, thus reducing the occurrence of a decrease in current density due to the skin effect.

The electric wire of the present invention preferably has an insulating film on the outer surface of the conductive pipe. By the insulating film being provided on the outer surface of the conductive pipe, insulation between the electric wires is held when the electric wire of the present invention is wound.

The cross-sectional outer shape of the conductive pipe is preferably a “rectangle” or a “hexagon” so as to be wound without any space. The “rectangle” includes a rectangle with chamfered corners and rectangle with rounded corners. The “hexagon” includes a hexagon with chamfered corners and a hexagon with rounded corners. When the wire is not wound like the transmission wire, the cross-sectional outer shape of the conductive pipe may be a “circle”. The “circle” includes a circle with distortion in a practically acceptable range.

Each material of the conductive wire and the conductive pipe is preferably any one of copper, a copper alloy, aluminum and an aluminum alloy, or a combination of those in view of electrical conductivity, workability, cost, durability and the like. “Copper” includes copper having a slight amount of added ingredient. “Aluminum” includes aluminum having a slight amount of added ingredient.

The conductive wire divided into a plurality of regions by the first insulating film extending in the longitudinal direction is obtained by making the directions of a plurality of thin conductive wires whose surfaces are coated by the insulating film uniform and integrating the conductive wires. It is preferable to simultaneously integrate the conductive pipe at the time of integrating the plurality of thin conductive wires.

As a method for integrating the plurality of thin conductive wires and the conductive pipe, the following method is preferably used: (a) preparing a conductor tape; (b) preparing a plurality of thin conductive wires whose surfaces are coated by an insulating film; (c) making directions of the plurality of thin conductive wires uniform and placing the wires on the conductor tape; (d) rolling the conductor tape and bonding the longitudinal end surface of the conductor tape to give a conductive pipe, and accommodating the plurality of thin conductive wires inside the conductive pipe; and (e) integrating the plurality of thin conductive wires and the conductive pipe, forming a conductive wire having a plurality of regions divided by a first insulating film, while simultaneously surrounding the conductive wire in the longitudinal direction without any space by means of the conductive pipe via a second insulating film. According to this method, it is possible to manufacture a long electric wire with ease since there are no limitations on the lengths of the conductive wire and the conductive pipe.

The electric wire (integrated conductive pipe and conductive wire) of the present invention is preferably annealed. At the time of integrating the conductive wire and the conductive pipe, the conductive wire and the conductive pipe are work-hardened so as to be transformed. Since the hardness of the conductive wire and the conductive pipe is high when they remain as they are, winding the electric wire (conductive wire and conductive pipe) is difficult. For this reason, the electric wire is annealed to decrease the hardness. This can facilitate winding of the electric wire.

The method for manufacturing an electric wire according to the present invention preferably includes a step of coating the outer surface of the conductive pipe by the insulating film. The outer surface of the conductive pipe is coated by the insulating film, thereby to hold insulation between the electric wires in the case of winding the electric wire of the present invention.

### Examples

Examples of the electric wire of the present invention will now be described. Materials and sizes described below are one example and the present invention is not limited thereto.

FIGS. 1 (a) to 1 (f) are views showing, by means of cross sections, one example of an electric wire 10 and a manufacturing process thereof according to the present invention in the order of manufacturing steps.

FIG. 1 (a) is a sectional view of a thin conductive wire 12a as a material for the electric wire 10 of the present invention. The surface of the thin conductive wire 12a is coated by an insulating film 13. The thin conductive wire 12a is typically a thin copper wire. The insulating film 13 is typically a single-layered film or a multi-layered film made of polyester, polyamide-imide or the like. A diameter of the thin conductive wire 12a is, for example, 0.5 mm and a thickness of the insulating film 13 is, for example, 30 μm.

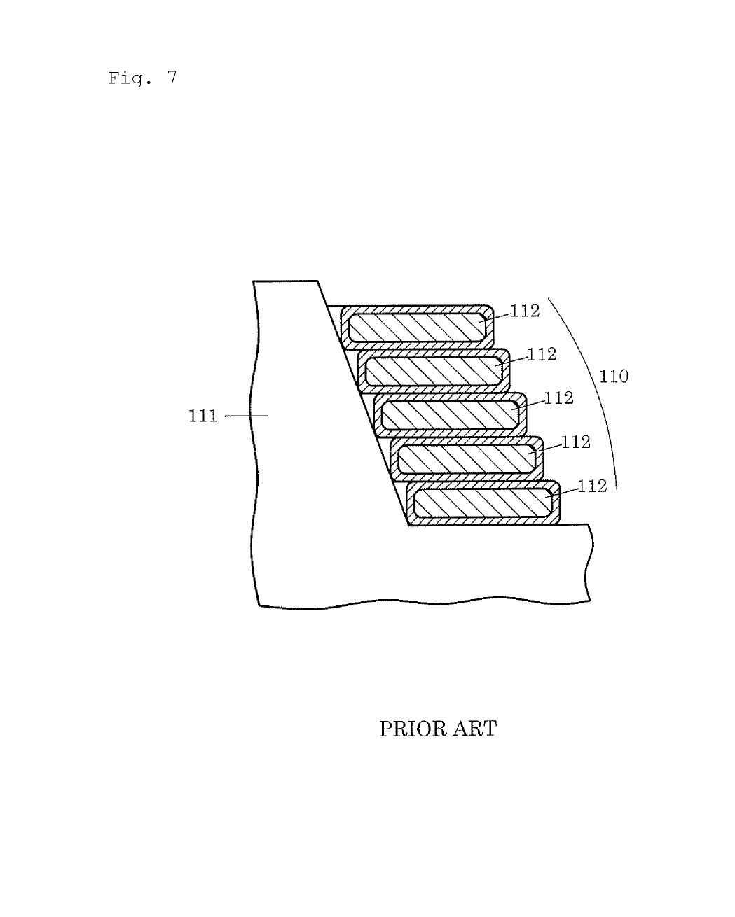

In the motor using the electric wire 10 of the present invention, since a frequency of a drive current is about 8 kHz, the skin depth of copper is about 0.8 mm, as seen from FIG. 7. Therefore, in the thin conductive wire 12a of a diameter 0.5 mm, the skin effect can be almost ignorable and a current flows across the cross section of the thin conductive wire 12a.

As shown in FIG. 1 (b), for the sake of easy handling, nine thin conductive wires 12a are stranded to form a thin conductive wire bundle 14. The thin conductive wires 12a may not be stranded, but may be arrayed in parallel to form the thin conductive wire bundle 14.

As shown in FIG. 1 (c), the thin conductive wire bundle 14 is inserted into a conductive pipe 15. The conductive pipe 15 is typically a copper pipe. An inner diameter of the conductive pipe 15 is, for example, 3.2 mm, an outer diameter is, for example, 4 mm and a wall thickness is, for example, 0.4 mm. With the skin depth of copper at 8 kHz is about 0.8 mm, the skin effect can be almost ignorable also in the conductive pipe 15, and the current flows across the cross section of the conductive pipe 15.

As shown in FIG. 1 (d), the thin conductive wire bundle 14, the insulating film 13 and the conductive pipe 15 are integrated by a drawing process. After integration, the thin conductive wire bundle 14 becomes a conductive wire 12b. After integration, an inner diameter of the conductive pipe 15 is, for example, 1.7 mm, an outer diameter is, for example, 2.5 mm and a wall thickness is, for example, 0.4 mm. Attention should be paid for preventing occurrence of cracking in the insulating film 13 at the time of the drawing process. As for the electric wire not to be wound, such as the transmission wire, the processing may be completed in the step of FIG. 1 (d) as a completed product.

As shown in FIG. 1 (e), the cross-sectional outer shape of the conductive pipe 15 is transformed into a rectangle by the drawing process. An outer size of the conductive pipe 15 is, for example, 3.2 mm×1.7 mm and a wall thickness thereof is, for example, 0.4 mm. The conductive wire 12b is also transformed as in the figure.

As shown in FIG. 1 (f), the outside of the conductive pipe 15 is coated by an insulating film 16, to complete the electric wire 10 of the present invention. The electric wire 10 of the present invention shown in FIG. 1 (f) comprises: the conductive wire 12b having nine regions divided by a first insulating film 13a; a second insulating film 13b for insulating the conductive wire 12b and the conductive pipe 15; and the insulating film 16 that coats the surface of the conductive pipe 15. Since the conductive wire 12b is divided into the nine regions, a surface area of the conductive wire 12b increases, to reduce the influence of the skin effect. Since the electric wire 10 shown in FIG. 1 (f) has a rectangular cross section, it can be wounded without any space similarly to the stator coil 110 (FIG. 6) of the conventional motor. Since the electric wire 10 shown in FIG. 1 (f) is thick, it is easy to wind without any space in terms of production techniques.

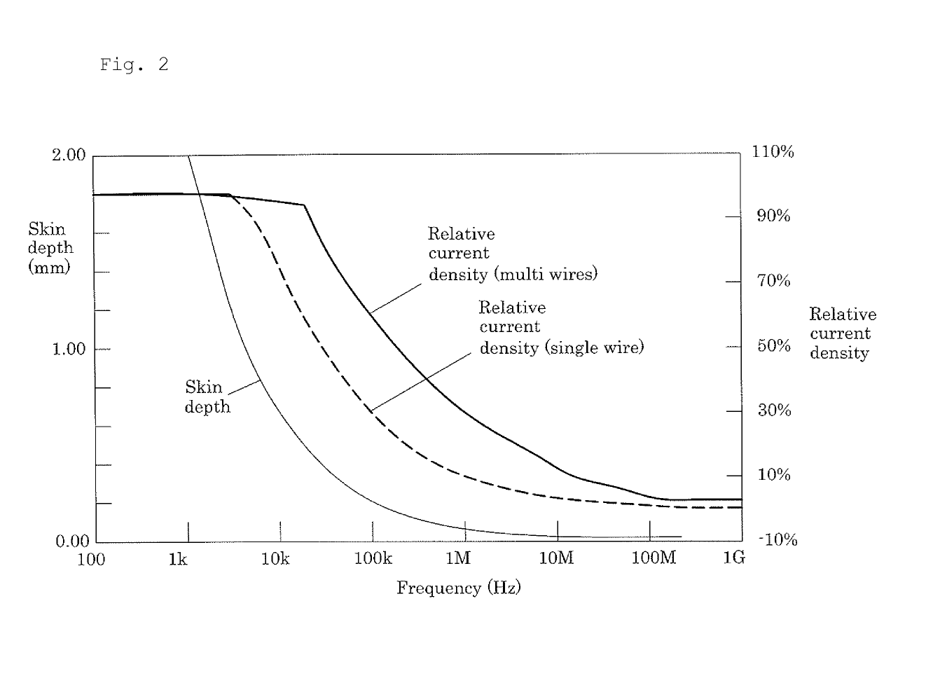

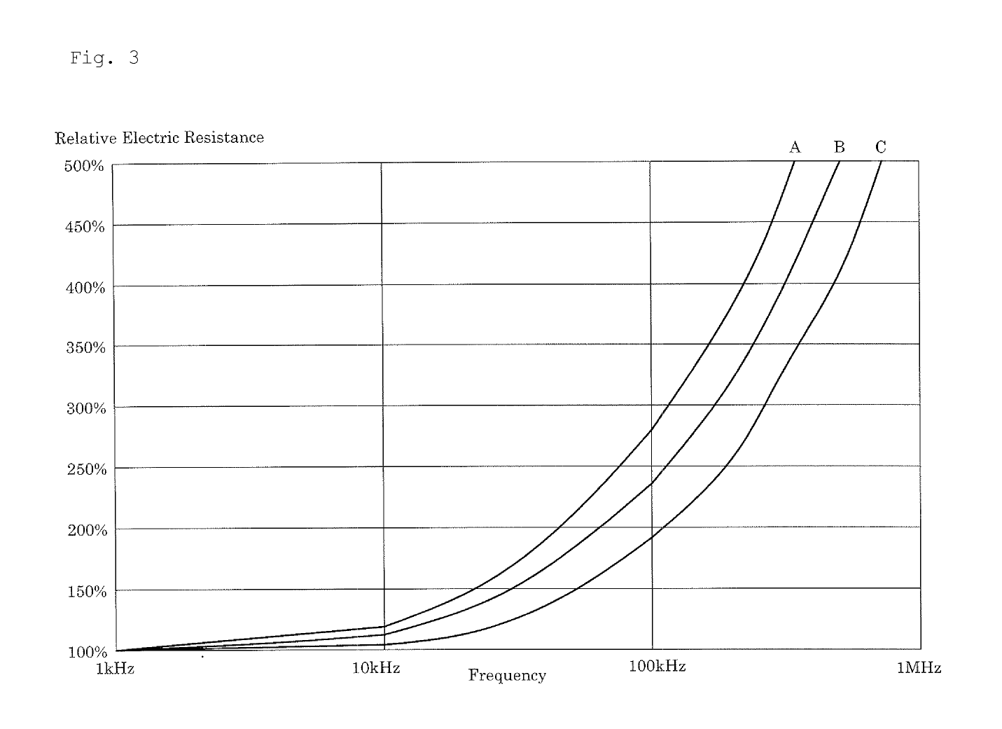

FIG. 2 is a graph (calculated value) showing a skin effect alleviation status of the electric wire 10 of the present invention. A horizontal axis, a left vertical axis and a right vertical axis of FIG. 2 respectively represent a current frequency, a skin depth and a relative current density. The relative current density of the right vertical axis of FIG. 2 displays the case of a direct current as 100%. FIG. 2 is a calculated value obtained using a copper-made coil wire (single wire) having a rectangular cross section of 3.2 mm×1.7 mm as a model, and a calculated value obtained using the electric wire 10 (multi wires) of the present invention shown in FIG. 1 as a model. The cross section of the electric wire 10 of the present invention is a rectangle of 3.2 mm×1.7 mm. The calculated value of the copper-made coil wire (single wire) is a graph indicated as a relative current density (single wire), and the calculated value of the electric wire 10 of the present invention is a graph indicated as a relative current density (multi wires).

As seen from FIG. 2, in the case of the copper-made (single wire) coil wire, when the current frequency exceeds about 4 kHz, a relative current density decreases. The relative current density decreases to 50% at the current frequency of about 30 kHz, and the relative current density decreases to 20% at the current frequency of about 200 kHz.

On the other hand, in the case of the electric wire 10 of the present invention, the relative current density does not decrease down to the current frequency of about 20 kHz. When the current frequency exceeds about 20 kHz, the relative current density decreases, but the relative current density is constantly higher than the copper-made coil wire (single wire) up to about 100 MHz. Hence by use of the electric wire 10 of the present invention from about 4 kHz to about 100 MHz, it is possible to alleviate the skin effect more than the copper-made coil wire (single wire). Accordingly, the electric wire 10 of the present invention can be used at a higher current density than the conventional rectangular coil wire 112 (single wire) from about 4 kHz to about 100 MHz.

FIG. 3 shows frequency dependencies (measured values) of resistance values of the electric wire of the present invention and the conventional electric wire. A horizontal axis and a vertical axis of FIG. 3 respectively represent a current frequency and a relative electric resistance. A graph A is the case of a conventional electric wire (single wire having a rectangular cross section of 3.2 mm×1.7 mm). A graph B is the case of a second example of the electric wire of the present invention (the electric wire formed by integrating 10 thin conductive wires each with a diameter of 0.5 mm and a conductive pipe with a thickness of 0.4 mm, and having a rectangular cross section of 3.2 mm×1.7 mm). A graph C is the case of a third example of the electric wire of the present invention (the electric wire formed by integrating 260 thin conductive wires each with a diameter of 0.1 mm and a conductive pipe with a thickness of 0.3 mm, and having a rectangular cross section of 3.2 mm×1.7 mm).

As is apparent from FIG. 3, the increase in resistance value is smaller at a high frequency in the electric wires (B, C) of the present invention than in the conventional electric wire (A). The third example (C) of the electric wire of the present invention is larger in number of thin conductive wires than the second example (B). For this reason, in the third example (C), the thin conductive wire has a larger surface area and the skin effect has a smaller influence. Consequently, the rise in resistance value at a high frequency is smaller in the third example (C) of the electric wire of the present invention than in the second example (B) thereof.

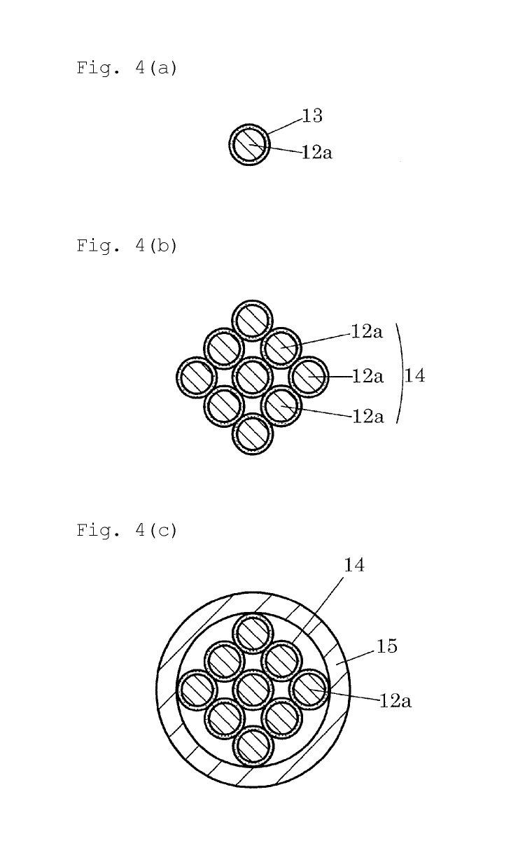

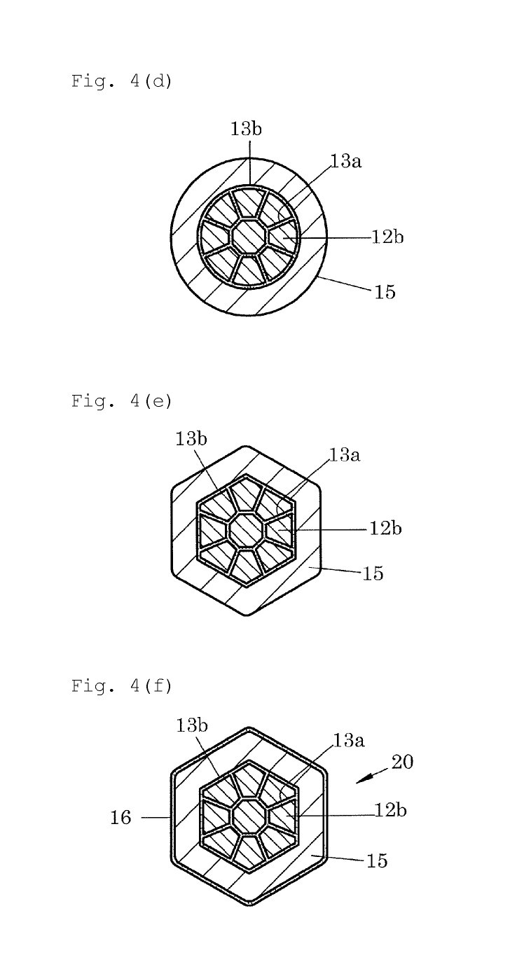

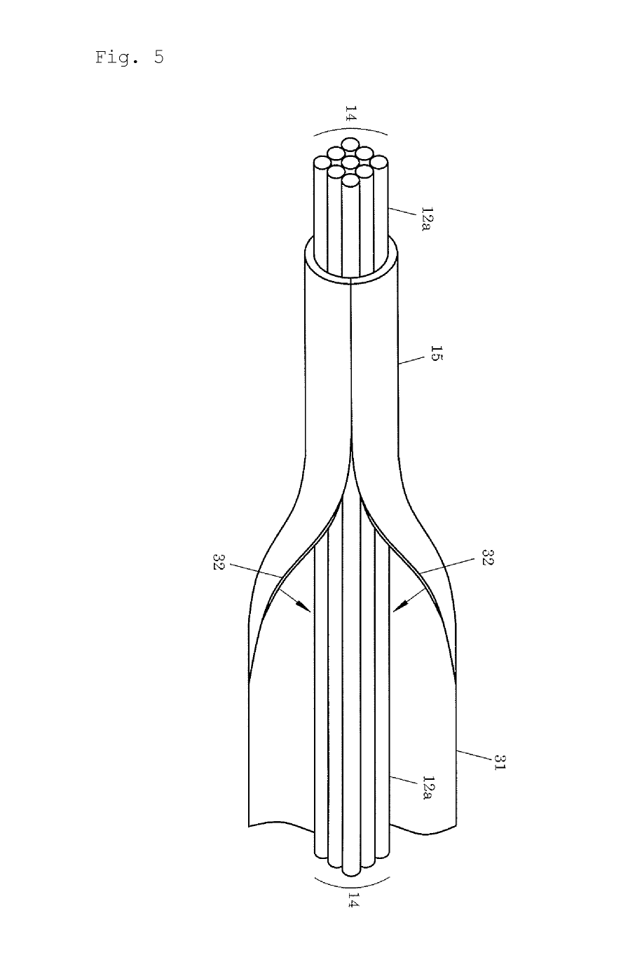

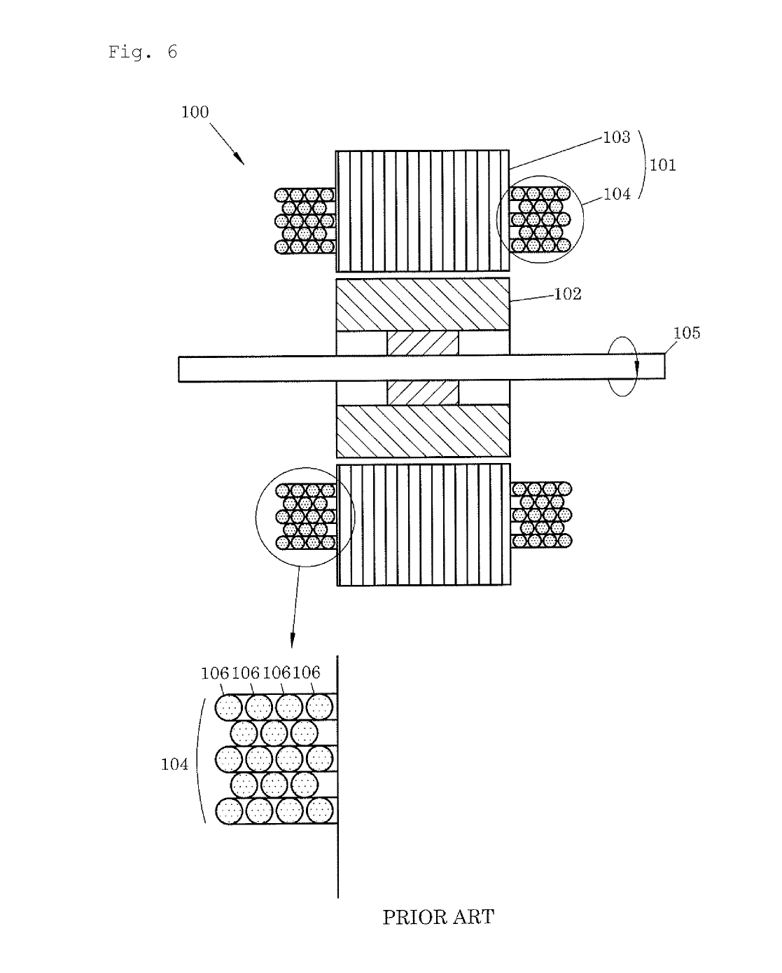

FIGS. 4 (a) to 4 (f) are views showing, by means of sectional views, a fourth example of an electric wire 20 of the present invention and a manufacturing process therefor in the order of manufacturing steps. Portions in common with FIG. 1 are provided with the same reference numerals.

FIG. 4 (a) is a sectional view of a thin conductive wire 12a as a material for the electric wire 20 of the present invention. A size, a material and the like of the thin conductive wire 12a are the same as those of the electric wire 10 of FIG. 1.

FIG. 4 (b) is a thin conductive wire bundle 14 formed by stranding nine thin conductive wires 12a. This is the same one as the thin conductive wire bundle 14 of FIG. 1.

FIG. 4 (c) is a view where the thin conductive wire bundle 14 has been inserted into a conductive pipe 15. A size, a material and the like of the conductive pipe 15 are the same as those of the conductive pipe 15 of FIG. 1.

FIG. 4 (d) is a view where the thin conductive wire bundle 14, the insulating film 13 and the conductive pipe 15 have been integrated. After integration, the thin conductive wire bundle 14 becomes a conductive wire 12b. The size and the like of the conductive pipe 15 after integration are the same as those of the conductive pipe 15 of FIG. 1. As for the electric wire not to be wound, such as the transmission wire, the processing may be completed in the step of FIG. 4 (d) as a completed product.

As shown in FIG. 4 (e), the cross-sectional outer shape of the conductive pipe 15 is transformed into a hexagon by the drawing process. An outer size of the conductive pipe 15 is, for example, 0.82 mm per side and a wall thickness thereof is, for example, 0.4 mm. The conductive wire 12b is transformed as in the figure.

As shown in FIG. 4 (f), the outside of the conductive pipe 15 is coated by the insulating film 16 to complete the electric wire 20 of the present invention. Since the electric wire 20 shown in FIG. 4 (f) has a hexagonal cross section, it can be wound without any space. Since the electric wire 20 shown in FIG. 4 (f) is thick, it is easy to wind without any space.

FIG. 5 is one example of a manufacturing method for the present invention where the thin conductive wire bundle 14 consists of a plurality of thin conductive wires 12a is continuously inserted into the conductive pipe 15. The process goes from the right toward the left in FIG. 5. The right portion of FIG. 5 is a step of placing the thin conductive wire bundle 14 consisting of the plurality of thin conductive wires 12a on a conductor tape 31 (e.g., thin copper tape). The surface of the thin conductive wire 12a is coated by an insulating film (not shown). The central portion of FIG. 5 is a step of rolling the conductor tape 31 and bond a longitudinal end surface 32 to produce the conductive pipe 15. In this step, the thin conductive wire bundle 14 is accommodated into the conductive pipe 15. The left portion of FIG. 5 shows the thin conductive wire bundle 14 inserted in the conductive pipe 15. According to the manufacturing process of FIG. 5, there is no limitations on the lengths of the conductive pipe 15 and the thin conductive wire bundle 14, and it is thus possible to continuously produce the long thin conductive wire bundle 14 inserted in the long conductive pipe 15.

At the time of integration of the conductive wire and the conductive pipe, the conductive wire and the conductive pipe are work-hardened in order to transform the conductive wire and the conductive pipe. The electric wire has a high hardness when remaining work-hardened, and is thus difficult to wind. For this reason, the electric wire is annealed to decrease the hardness. The annealing can facilitate winding of the electric wire. An annealing condition is, for example, 230° C./1 hour or 250° C./2 hours. In order not to degrade the insulating film at the time of annealing, an insulating film (e.g. polyamide-imide insulating film) with a heat resistance of not lower than 300° C. is used.

A bending test on the electric wire of the present invention (rectangular cross section of 3.2 mm×1.7 mm) was performed before and after annealing. The 3.2-mm side of the electric wire was bent by 180° along respective round bars with diameters of 8 mm, 4 mm and 2 mm. Further, the 3.2-mm side of the electric wire was bent by 180° without a round bar. Since the electric wire before annealing has high hardness, it was not possible to bend the electric wire along any of the respective round bars with diameters of 8 mm, 4 mm and 2 mm, and spaces of several mm were generated between the electric wire and the round bars. Further, when the electric wire was bent along the round bar with a diameter of 2 mm and bent without a round bar, cracking occurs in a bent portion. Since the electric wire after annealing has low hardness, it was possible to bend the electric wire along any of the respective round bars with diameters of 8 mm, 4 mm and 2 mm without any space. In any one of the cases where the electric wire was bent along the respective round bars with diameters of 8 mm, 4 mm and 2 mm and bent without a round bar, cracking did not occur in the electric wire.

Finally, the surface of the electric wire (outer surface of the conductive pipe 15) was coated by the insulating film 16. The surface of the electric wire was coated by the insulating film 16, thereby to hold insulation between the electric wires 10 when the electric wire 10 is wound. Either the step of coating the surface of the electric wire by the insulating film 16 or the annealing step may be performed in advance of the other.

The electric wire of the present invention is preferably used for a motor (electric motor), a generator coil or a transmission wire.

There has thus been shown and described a novel electric wire which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An electric wire, comprising:
a conductive wire divided into a plurality of regions by a first insulating film extending in a longitudinal direction;
a second insulating film that coats a longitudinal periphery of the conductive wire; and
a conductive pipe that surrounds, without any space, the conductive wire in the longitudinal direction while sandwiching the second insulating film.

2. The electric wire according to claim 1, wherein each of the plurality of divided regions of the conductive wire has a minor axis less than twice as large as a skin thickness at a working frequency, and a wall thickness of the conductive pipe is smaller than the skin thickness at the working frequency.

3. The electric wire according to claim 1, having an insulating film on an outer surface of the conductive pipe.

4. The electric wire according to claim 2, having an insulating film on the outer surface of the conductive pipe.

5. The electric wire according to claim 1, wherein a cross-sectional outer shape of the conductive pipe is a circle, a rectangle or a hexagon.

6. The electric wire according to claim 2, wherein a cross-sectional outer shape of the conductive pipe is a circle, a rectangle or a hexagon.

7. The electric wire according to claim 1, wherein each material of the conductive wire and the conductive pipe is any one of copper, a copper alloy, aluminum and an aluminum alloy, or a combination of those.

8. The electric wire according to claim 2, wherein each material of the conductive wire and the conductive pipe is any one of copper, a copper alloy, aluminum and an aluminum alloy, or a combination of those.

9. A method for manufacturing an electric wire, comprising the steps of:
preparing a conductor tape;
preparing a plurality of thin conductive wires whose surfaces are coated by an insulating film;
making directions of the plurality of thin conductive wires uniform and placing the wires on the conductor tape;
rolling the conductor tape and bonding a longitudinal end surface of the conductor tape to give a conductive pipe, and accommodating the plurality of thin conductive wires inside the conductive pipe; and
integrating the plurality of thin conductive wires and the conductive pipe, forming a conductive wire having a plurality of regions divided by a first insulating film, while simultaneously surrounding the conductive wire in a longitudinal direction without any space by means of the conductive pipe via a second insulating film.

10. The method according to claim 9, further comprising a step of annealing the integrated conductive pipe and the plurality of conductive wire.

11. The method according to claim 9, further comprising a step of coating the outer surface of the conductive pipe by an insulating film.

12. The method according to claim 10, further comprising a step of coating the outer surface of the conductive pipe by an insulating film.
